(19) United States
(12) Patent Application Publication
(10) Pub. No.: US 2005/0044765 A1
(43) Pub. Date: Mar. 3, 2005

(54) Holder device for mounting on shelves in shops

(75) Inventors: Bengt Ahlund, Sollentuna (SE); Marten Sjoberg, Stockholm (SE); Borje Josefsson, Sorberge (SE)

Correspondence Address: SUGHRUE MION, PLLC, 2100 PENNSYLVANIA AVENUE, N.W., SUITE 800, WASHINGTON, DC, 20037, US

(73) Assignee: HL DISPLAY AB

(21) Appl. No.: 10/504,024

(22) PCT Filed: Jan. 24, 2003
(86) PCT No.: PCT/SE03/00123

(30) Foreign Application Priority Data
Feb. 21, 2002 (SE) 0200512-2

(51) Int. Cl. G09F 3/20

(52) U.S. Cl. 40/649

(57) ABSTRACT

The invention relates to a holder for mounting on shelves in shops and department stones and intended for inter alia advertising messages in sheet form, product samples and the like. The shelves are divided into compartments by means of dividers (2) which extend between the front and rear edges of the shelf and, at their front ends, are made with a gripping part (3) comprising two gripping claws which are separated by an intermediate slot (4) and are intended to engage with a mounting strip (7) running along the front edge of the shelf. The holder (11) has a slotted portion which makes it possible for it to be slipped onto the front end edge of the divider (2), and, extending downward from this portion, two legs with opposite locking projections (19) which are adapted to enter into locking engagement in the slot (4) between the gripping claws when the holder is slipped onto the divider.

### FIELD OF THE INVENTION

The present invention relates to a holder for mounting on shelves in shops and department stores and intended for inter alia advertising messages in sheet form, product information, product samples and the like, which shelves are divided into compartments by means of dividers which extend between the front and rear edges of the shelf and, at their front ends, are made with a gripping part comprising two gripping claws which are separated by an intermediate slot and are intended to engage with a mounting strip running along the front edge of the shelf.

### BACKGROUND OF THE INVENTION

In many situations, it is desirable for it to be possible to attach, for example, advertising messages in sheet form or other product information to shelves in shops and department stores. When some types of product are displayed, the shelves are divided into compartments by means of dividers extending between the front and rear edges of the shelf. In this connection, inter alia advertising messages and the like, usually referred to as flags, are today mounted in holes in the front edge of the shelf between the dividers. This means, however, that they render more difficult both the placing of merchandise on and the removal of merchandise from the shelf compartment concerned.

### THE OBJECT OF THE INVENTION

One object of the present invention is to solve this problem so that, for example, advertising flags can be attached to shelves in such a way that they do not constitute an obstruction.

The invention is based on the realization that this can be achieved if the flags can be mounted on the dividers at the side of the merchandise compartment concerned.

In this connection, a holder of the type indicated in the first paragraph is characterized in particular in that the holder has a slotted portion which makes it possible for it to be slipped onto the front end edge of the divider, and, extending downward from this portion, two legs with protruding locking projections which are adapted to enter into locking engagement in the slot between said gripping claws when the holder is slipped onto the divider.

By using a holder of this type, it is therefore possible to mount, for example, a flag directly on a divider, which means that it does not hinder access to the merchandise compartment. Furthermore, the system is entirely independent of the design of the shelf and any holes in it, as the holder is mounted on the divider. By virtue of the fact that, thanks to its slotted portion, the holder can be slipped onto the front end edge of the divider, very good guidance of the holder in the lateral direction is obtained.

The locking projections are suitably made so that they enter into engagement in the slot between the gripping claws above those portions thereof which engage with the mounting strip on the shelf. As a result, the holder does not interfere in any way with the mounting of the divider on the mounting strip of the shelf. The locking projections suitably have an essentially rectangular shape for bringing about good guidance in the slot in the divider.

It is preferred that the legs of the holder have downwardly projecting portions which, in the mounted state on a divider, project down on the outside of the mounting strip on the shelf in order to prevent an outward pivoting movement of the holder around the locking projections.

For similar reasons, the slot of the holder intended for receiving the divider has a bottom contour which closely follows the contour of the end edge of the divider in order thus to prevent an inward pivoting movement of the holder around the locking projections.

As the upper part of the holder is intended for securing an advertising message in sheet form, it is suitably made in the form of two side portions, prestressed toward one another, with an intermediate slot, in which guide means intended to interact with a sheet inserted into the slot are arranged.

The holder is suitably manufactured in one piece by injection molding a plastic material.

Further features of the invention emerge from the following patent claims.

The invention will be described in greater detail below with reference to the embodiments shown by way of example in accompanying drawings.

### BRIEF DESCRIPTION OF THE DRAWINGS

FIG. 1 shows diagrammatically a shop shelf with flags mounted on dividers, in accordance with the invention.

FIGS. 2 and 3 show how the dividers are mounted on the shelf according to FIG. 1.

FIGS. 4 and 5 show two perspective views of a holder according to the invention for mounting on a divider.

FIG. 6 shows the holder mounted on a divider with a flag mounted.

FIG. 7 is a vertical section through the slot between the two side portions of the holder with a flag mounted.

FIGS. 8 and 9 show another application of a holder according to the invention.

### DETAILED DESCRIPTION OF THE PREFERRED EMBODIMENT

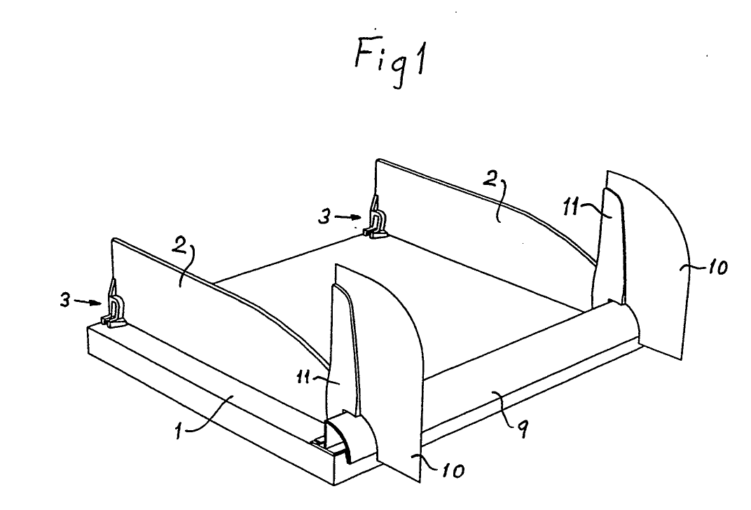

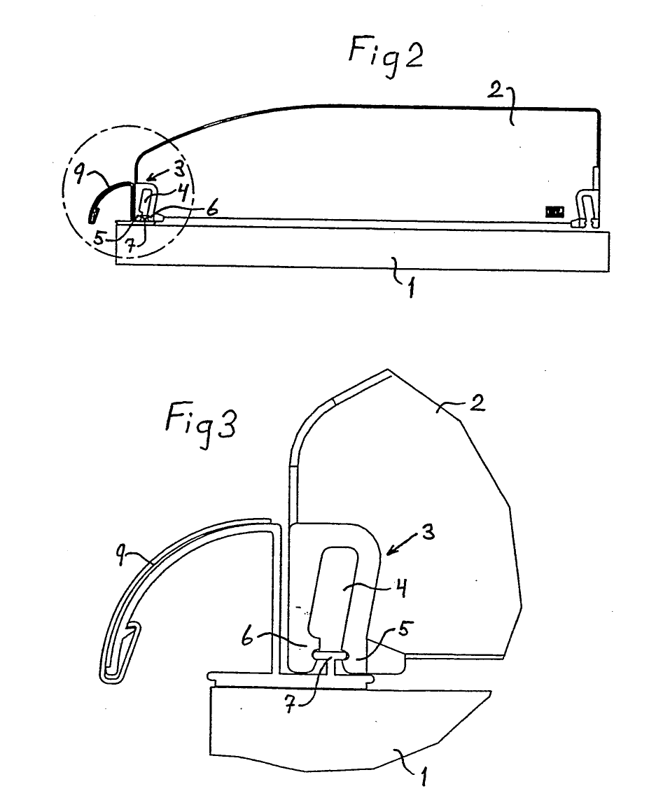

In FIG. 1, reference number 1 designates a shop shelf which is divided into compartments by means of dividers 2 mounted between its front and rear edges. In the embodiment shown (see also FIGS. 2 and 3), the dividers are, both at their front and rear edge, provided with gripping parts 3, each comprising two gripping claws 5, 6 which are separated by an intermediate slot 4 and engage with mounting strips 7, in the form of T-shaped profiles, running along the front and rear edges of the shelf. At the front edge of the shelf, there is a curved holder 9 for advertising signs or labels with other information, such as conventional merchandise and price labels. Advertising flags 10 are mounted on the dividers 2 in FIG. 1 using holders 11 according to the present invention. This mounting of the advertising flags means that they in no way hinder access to the products on the shelf.

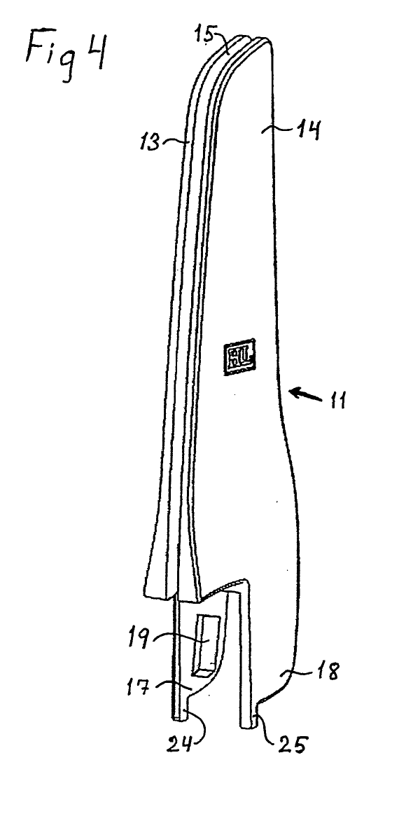

FIGS. 4 and 5 are perspective views of a holder 11 according to the present invention. The holder is made in the form of two sidepieces 13 and 14 which are held together at points and between them form a gap 15 for receiving an advertising flag. Thanks to the slot 15, the holder 11 can be mounted on the front end edge of a divider 2 by virtue of the holder being slipped onto the divider which is then received in the lower part 12 of the slot. The downwardly extending legs 17, 18 of the holder 11 will then project down over the two gripping claws of the gripping part 3 of the divider. On the inside of the legs 17, 18, there are two oppositely directed locking projections 19 which will then snap into the slot 4 located between the gripping claws of the divider. The projections 19 enter into engagement with that part of the slot 20 which, when the divider 2 is mounted, is located above those parts of the gripping claws 5, 6 interacting with the mounting strip 7 on the shelf 1. The projections 19 suitably have a rectangular shape, which leads to the holder 11 being fixed in the desired position relative to the divider.

In order to facilitate the snapping of the holder 11 firmly onto a divider 2, the lower end surfaces of the rectangular projections 18 are suitably slightly beveled. The holder is manufactured in one piece by injection molding a suitable plastic material, which means that the legs 17, 18 are slightly resilient, so that the holder can be snapped firmly onto a divider 2.

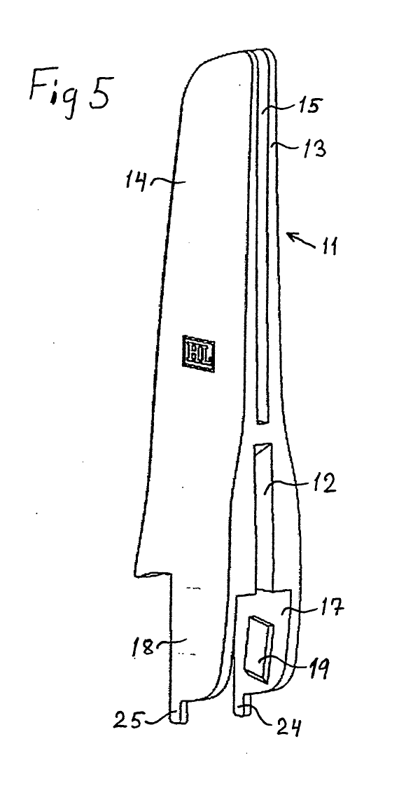

FIG. 6 shows a divider 2 with a holder 11 mounted and a flag 10 secured in the holder. In this connection, it can be seen that a front end portion of the divider 2 is inserted into the slot 12 in the holder 11 and that the locking projections 19 enter into engagement with and are guided in the slot 4 of the divider.

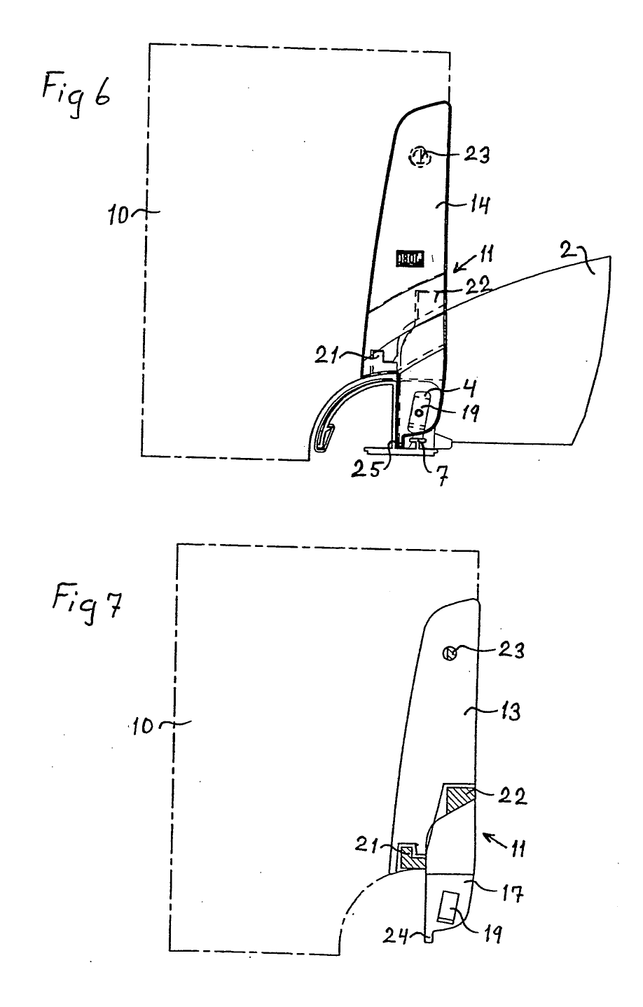

Reference numbers 21 and 22 designate material portions which connect the two sidepieces 13, 14 of the holder. The flag 10, which is inserted into the slot 15 between the sidepieces 13 and 14, is then made with corresponding cutouts, which means that the flag is fixed in a predetermined position in the holder 11 (see also FIG. 7). For securing and orienting the flag, the sidepiece 13 is also provided with an inner projection 23 which protrudes toward the other sidepiece 14 and is received in an opening made in the flag 10. The end surface of the projection 23 is suitably beveled in order to facilitate insertion of a flag between this end and the sidepiece 14 of the holder 11. The sidepieces 13 and 14 are suitably prestressed toward one another, so that, in the functioning position, the free end surface of the projection 23 bears against the opposite sidepiece. This means that a flag 10 is secured very firmly in the holder and as a result retains the desired orientation in relation to the divider 2.

The legs 17, 18 of the holder are made with downwardly protruding projections 24, 25 which, in the mounted position, are located in front of the mounting strip 7 running on the shelf 1. This means that, in the mounted position, the holder 11 cannot be pivoted outward around the locking projections 19. The material portions 21 and 22 connecting the sidepieces 13 and 14 are located next to the front end edge of the divider 2. This means that, in the mounted position, the holder 11 cannot be pivoted inward around the locking projections 19 either.

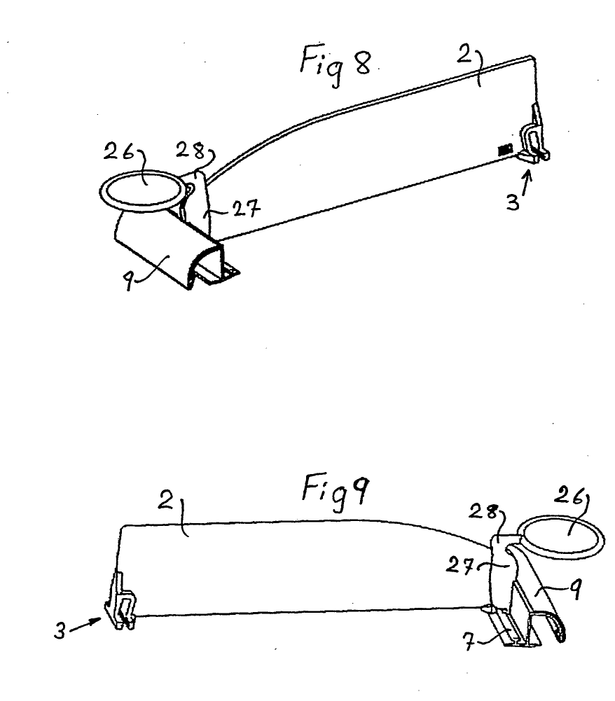

A holder as above can be used for attaching other objects to a divider. FIGS. 8 and 9 show an example in which it is desirable to mount a small shelf 26 for a merchandise sample on a divider 2. For this, a holder 27 is provided with an arm 28, on which a shelf can be mounted. As far as the parts interacting with the divider 2 are concerned, the holder 27 is identical with the holder 11 described above. Apart from a shelf 26, an object as required can be connected to the arm, for example a merchandise prong for merchandise samples. The arm 28 can also be exchanged for a universal attachment of the desired design.

The invention has been described above in connection with the embodiments shown in the drawings. However, these can be varied in several respects within the scope of the patent claims, in particular with regard to the detailed design of various parts which have to be adapted depending on the intended use.

1. A holder for mounting on shelves in shops and department stores and for advertising messages in sheet form, and product samples, which shelves are divided into compartments by means of dividers which extend between the front and rear edges of the shelf and, at their front ends, are made with a gripping part comprising two gripping claws which are separated by an intermediate slot and are intended to engage with a mounting strip running along the front edge of the shelf, characterized in that the holder has a slotted portion which makes it possible for it to be slipped onto the front end edge of the divider, and, extending downward from this portion, two legs with opposite locking projections which are adapted to enter into locking engagement in the slot between said gripping claws when the holder is slipped onto the divider.

2. The holder as claimed in claim 1, characterized in that said locking projections are adapted to enter into engagement in the slot between the gripping claws above those portions thereof which engage with said mounting strip on the shelf.

3. The holder as claimed in claim 1, characterized in that said locking projections have an essentially rectangular shape for good guidance in the slot.

4. The holder as claimed in claim 1, characterized in that an edge of each locking projection is beveled in order to facilitate mounting of the holder on a divider.

5. The holder as claimed in claim 1, characterized in that said legs provided with locking projections are slightly resilient.

6. The holder as claimed in claim 1, characterized in that said legs have downwardly projecting portions which, in the mounted state on a divider, project down on the outside of the mounting strip on the shelf in order to prevent an outward pivoting movement of the holder around said locking projections.

7. The holder as claimed in claim 1, characterized in that its slot intended for receiving the divider has a bottom contour which closely follows the contour of the end edge of the divider in order thus to prevent an inward pivoting movement of the holder around said locking projections.

8. The holder as claimed in claim 1, characterized in that its upper part intended for securing an advertising message in sheet form comprises two side portions, prestressed toward one another, with an intermediate slot, and guide means which extend into the slot and are intended to interact with a sheet inserted into the slot.

9. The holder as claimed in claim 1, characterized in that it is manufactured in one piece by injection molding a plastic material.
